(19) United States
(12) Patent Application Publication
(10) Pub. No.: US 2026/0094744 A1
(43) Pub. Date: Apr. 2, 2026

(54) MAGNETIC MATERIAL, MAGNETIC MATERIAL MANUFACTURING METHOD, AND INDUCTOR

(71) Applicant: Murata Manufacturing Co., Ltd., Kyoto-fu (JP)

(72) Inventors: Naoki OGAWA, Nagaokakyo-shi (JP); Masaaki HIRAYAMA, Nagaokakyo-shi (JP); Masaki KITAGAWA, Nagaokakyo-shi (JP); Masanori ABE, Nagaokakyo-shi (JP)

(73) Assignee: Murata Manufacturing Co., Ltd., Kyoto-fu (JP)

(21) Appl. No.: 19/276,664

(22) Filed: Jul. 22, 2025

(30) Foreign Application Priority Data
Sep. 27, 2024 (JP) 2024-168240

(51) Int. Cl. H01F 1/147; H01F 1/153; H01F 3/08; H01F 41/02

(52) U.S. Cl. CPC H01F 1/14766; H01F 1/15375; H01F 3/08; H01F 41/0246

(57) ABSTRACT

A magnetic material has magnetic powder containing a first magnetic particle and a second magnetic particle smaller in particle diameter than the first magnetic particle, and a resin. At least part of an outer peripheral surface of the first magnetic particle has a binding layer that contains a silane coupling agent.

### CROSS-REFERENCE TO RELATED APPLICATION

This application claims benefit of priority to Japanese Patent Application No. 2024-168240, filed Sep. 27, 2024, the entire content of which is incorporated herein by reference.

### BACKGROUND

### Technical Field

The present disclosure relates to a magnetic material, a magnetic material manufacturing method, and an inductor.

### Background Art

Inductors (coil components) having a metal magnetic body are widely used as, for example, surface-mountable chip inductors for various electrical apparatuses such as smartphones. Known examples of the metal magnetic body for such an inductor include a powder magnetic core or a base body (hereinafter referred to as “base body”), which is manufactured by compression molding of a magnetic material containing soft magnetic powder composed of metal particles being a soft magnetic substance and a resin.

International Publication No. 2023/190373 discloses that a solidified object (molded product) formed from a magnetic material can be improved in mechanical strength when the magnetic material contains a silane coupling agent.

However, the base body formed by compression of the magnetic material may fail to maintain a sufficient mechanical strength against high pressure inside the base body caused by, for example, sudden evaporation of absorbed moisture within the base body at the time of reflow, resulting in cracks inside the base body. The cracks inside the base body of the inductor leads to a decrease in inductance.

### SUMMARY

Accordingly, the present disclosure provides a magnetic material exhibiting high mechanical strength after compression molding.

A magnetic material according to one aspect of the present disclosure includes magnetic powder containing a first magnetic particle and a second magnetic particle smaller in particle diameter than the first magnetic particle, and a resin. At least part of an outer peripheral surface of the first magnetic particle has a binding layer that contains a silane coupling agent.

According to the magnetic material of the present disclosure, high mechanical strength can be exhibited after compression molding.

### BRIEF DESCRIPTION OF THE DRAWINGS

FIG. 1 is a schematic diagram illustrating a state of a magnetic material according to an embodiment;

FIG. 2 is an explanatory diagram for description of a configuration example of a first soft magnetic particle:

FIG. 3 is an explanatory diagram for description of a configuration example of a second soft magnetic particle:

FIG. 4 is an explanatory diagram for description of an outline of a process of manufacturing the magnetic material according to the embodiment:

FIG. 5 is an enlarged image of part of a fractured piece:

FIG. 6 is a perspective view schematically illustrating a configuration of an inductor:

FIG. 7 is a perspective view schematically illustrating the configuration of the inductor:

FIG. 8 is a transparent perspective view transparently illustrating an internal configuration of the inductor:

FIG. 9 is a cross-sectional view illustrating a cross-section orthogonal to a length direction of a conductive wire forming a coil:

FIG. 10 is an explanatory diagram for description of an outline of a process of manufacturing the inductor; and

FIG. 11 is an explanatory diagram for description of one aspect of formation of a base body.

### DETAILED DESCRIPTION

An embodiment of the present disclosure will be described below with reference to the drawings. Note that the drawings may partially include a schematic diagram. In addition, numerical values of dimensions or ratios in the schematic diagram may differ from actual ones.

### Magnetic Material

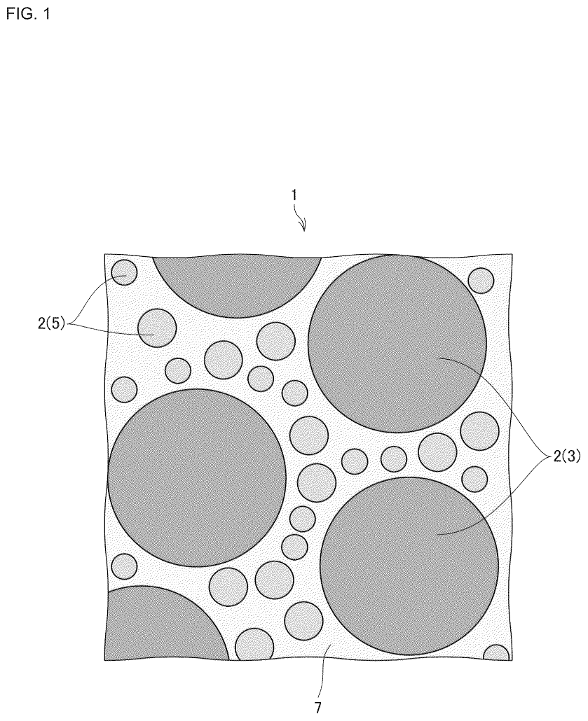

FIG. 1 is a schematic diagram illustrating a state of a magnetic material according to the embodiment. As illustrated in FIG. 1, a magnetic material 1 to be used for forming, for example, a base body of an inductor contains magnetic powder 2 and a resin 7.

The magnetic powder 2 is composed of soft magnetic metal particles. The magnetic powder 2 contains, for example, first soft magnetic particles 3 and second soft magnetic particles 5 smaller in average particle diameter than the first soft magnetic particles 3. In the present specification, the “average particle diameter” means the median diameter on a volume basis.

The average particle diameter of the first soft magnetic particles 3 and the average particle diameter of the second soft magnetic particles 5 can be measured by using a particle size analyzer before the particles are mixed together. In the case where the measurement is performed for a base body as a molded body formed by compression molding of the magnetic material 1, a cross-section of the base body obtained by polishing the base body is imaged by an electron microscope, and then the cross-sections of the first soft magnetic particles 3 and the second soft magnetic particles 5 are analyzed from the microscopic image. For example, equivalent circle diameters of the cross-sections of the first soft magnetic particles 3 and the second soft magnetic particles 5 are obtained from the electron micrograph. Subsequently, on the assumption that the first soft magnetic particles 3 and the second soft magnetic particles 5 be spheres having their respective equivalent circle diameters, the volumes of the spheres are obtained. On the basis of distribution of the volumes, the average particle diameter can be calculated from the median value.

The average particle diameter of the first soft magnetic particles 3 is 20 μm or more and 28 μm or less (i.e., from 20 μm to 28 μm), preferably 21.4 μm or more and 27.4 μm or less (i.e., from 21.4 μm to 27.4 μm). The average particle diameter of the second soft magnetic particles 5 is 1 μm or more and 6 μm or less (i.e., from 1 μm or more and 6 μm), preferably 1.5 μm or more and 1.8 μm or less (i.e., from 1.5 μm to 1.8 μm). Since the magnetic powder 2 is composed of the first soft magnetic particles 3 and the second soft magnetic particles 5 having different average particle diameters as described above, the first soft magnetic particles 3 having large average particle diameters contribute to enhance the saturation magnetic flux density of a base body and improve DC superimposition characteristics, whereas the second soft magnetic particles 5 having small average particle diameters enter gaps between the first soft magnetic particles 3 and thereby contribute to increase the filling factor of the magnetic powder 2 in the base body and improve the relative magnetic permeability.

The amount of the second soft magnetic particles 5 contained in the magnetic powder 2 is 15 wt % or more and 30 wt % or less (i.e., from 15 wt % to 30 wt %), preferably 20 wt % or more and 30 wt % or less (i.e., from 20 wt % to 30 wt %), with respect to the total weight of the magnetic powder 2. With the second soft magnetic particles 5 contained in the magnetic powder 2 within the above range, the filling factor of the magnetic powder 2 in the base body being the molded body of the magnetic material 1 can be further increased.

Although the composition of soft magnetic metal constituting the second soft magnetic particles 5 may be the same as the composition of soft magnetic metal constituting the first soft magnetic particles 3, it is preferable that the metals be different in composition but almost equivalent in hardness. The hardness of the first soft magnetic particles 3 and the hardness of the second soft magnetic particles 5 can be measured by using the nanoindentation method. For example, the hardness of the first soft magnetic particles 3 is 600 HV (kgf/mm2) or more and 1200 HV or less (i.e., from 600 HV (kgf/mm2) to 1200 HV), desirably 800 HV or more and 1000 HV or less (i.e., from 800 HV to 1000 HV). The hardness of the second soft magnetic particles 5 is 900 HV (kgf/mm2) or more and 1400 HV or less (i.e., from 900 HV (kgf/mm2) to 1400 HV), desirably 900 HV or more and 1100 HV or less (i.e., from 900 HV to 1100 HV).

The ratio of the hardness of the second soft magnetic particles 5 to the hardness of the first soft magnetic particles 3 is desirably 0.7 or more and 1.2 or less (i.e., from 0.7 to 1.2). This prevents deformation of either one of the first soft magnetic particles 3 or the second soft magnetic particles 5 which have a relatively low hardness at the time of compression molding of the magnetic material 1 containing the soft magnetic particles for the formation of the base body, preventing decrease in insulation resistance of the base body.

### First Soft Magnetic Particle

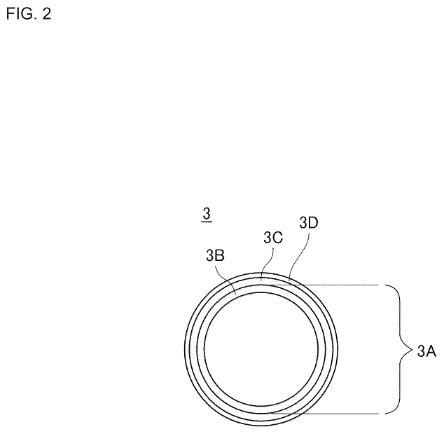

FIG. 2 is an explanatory diagram for description of a configuration example of the first soft magnetic particle 3. As illustrated in FIG. 2, the first soft magnetic particle 3 has a particle nucleus 3A composed of soft magnetic metal, and an insulating film 3C formed on the surface of the particle nucleus 3A. In addition, a binding layer 3D is at least partially formed on the surface of the insulating film 3C of the first soft magnetic particle 3, that is, on the outer peripheral surface of the first soft magnetic particle 3.

The particle nucleus 3A has an oxide film 3B which is formed by oxidization, on the surface of the particle nucleus 3A, of the soft magnetic metal constituting the particle nucleus 3A.

Specifically, the particle nucleus 3A is a non-crystalline (amorphous) or crystalline metal magnetic substance composed of an Fe—Si—Cr alloy or an Fe—Si alloy. The Fe—Si—Cr alloy or the Fe—Si alloy contains, for example, 87 wt % or more of Fe and 3 wt % or more of Si, and may contain B (boron).

The material of the particle nucleus 3A of the first soft magnetic particle 3 is not limited to the Fe—Si—Cr alloy or the Fe—Si alloy, and it is sufficient that the particle nucleus 3A be composed of an iron-based metal magnetic substance. Examples of the iron-based metal magnetic substance include non-crystalline or crystalline Fe—Si-Cr—Al or Fe—Si—Al alloys.

In the case where a Cr-free alloy is employed as the particle nucleus 3A of the first soft magnetic particle 3, the weight ratio of Fe in the particle nucleus 3A can be increased. Accordingly, a base body formed from such particle nuclei 3A can be further increased in saturation magnetic flux density, and can thus serve as an inductor having more appropriate superimposition characteristics.

The oxide film 3B can be formed by oxidization of the soft magnetic metal on the surface of the particle nucleus 3A during a process of manufacturing the particle nucleus 3A. For example, the oxide film 3B can be formed by exposing the particle nucleus 3A to water or an oxygen atmosphere during the process of manufacturing the particle nucleus 3A, and/or through a step of aggressively oxidizing the particle nucleus 3A, such as exposure to a high-temperature oxygen atmosphere.

The oxide film 3B increases in film thickness and in surface roughness as the oxidation of the soft magnetic metal progresses on the surface of the particle nucleus 3A, leading to increase in fixation strength between the oxide film 3B and the insulating film 3C formed on the surface thereof. On the other hand, as the film thickness of the oxide film 3B increases along with the progress of the oxidation of the soft magnetic metal, the amount of soft magnetic metal contained in the particle nucleus 3A decreases and accordingly the filling factor of actual soft magnetic metal in a base body formed from the particle nuclei 3A decreases. From the viewpoint of ensuring the fixation strength of the insulating film 3C and restricting the decrease in the amount of the actual soft magnetic metal to a certain range, a desirable oxygen content of the particle nucleus 3A is 900 ppm or more and 2800 ppm or less (i.e., from 900 ppm to 2800 ppm).

The insulating film 3C formed on the oxide film 3B is, for example, an inorganic glass coating formed by a mechanochemical method. The inorganic glass coating is composed of, for example, low-melting glass such as zinc phosphate, calcium phosphate, or manganese phosphate glass. Alternatively, the insulating film 3C may be composed of an organic polymer coating, an organic-inorganic hybrid coating, or an inorganic insulating coating. The above-described insulating film 3C can be formed by a mechanochemical method, by subjecting a metal alkoxide to a sol-gel reaction, or other methods, depending on the material.

The thickness of the insulating film 3C is 10 nm or more and 50 nm or less (i.e., from 10 nm to 50 nm). With the insulating film 3C having a thickness of 10 nm or more, the specific resistance of the first soft magnetic particle 3 can be increased. With the insulating film 3C having a thickness of 50 nm or less, the first soft magnetic particle 3 has a high ratio of metal and thus a base body formed therefrom has appropriate magnetic properties.

According to the first soft magnetic particle 3 having the above-described configuration, the fixation strength of the insulating film 3C formed on the oxide film 3B of the particle nucleus 3A is ensured and thereby a high withstanding voltage of the base body can be stably achieved, while the relative magnetic permeability of the base body can be kept high.

Regarding the base body formed by compression of the magnetic material, a mechanism of generation of cracks caused by pressure generated due to, for example, sudden evaporation of absorbed moisture within the base body at the time of reflow is not restricted by any specific theory, but is surmised as follows. The moisture absorbed into the inside of the base body suddenly evaporates at the time of reflow, generating a high pressure. The pressure causes a crack starting from the interface between the first soft magnetic particle 3 and the resin 7 (the outer peripheral surface of the first soft magnetic particle 3). The crack causes decrease in L value (inductance) of the inductor including the base body.

In this regard, the present inventors have found that the outer peripheral surface of the first soft magnetic particle 3 can be more strongly bonded to the resin 7 by, not merely adding the silane coupling agent to the magnetic material 1, forming the binding layer 3D containing the silane coupling agent on at least part of the outer peripheral surface of the first soft magnetic particle 3. Accordingly, the base body formed by compression of the magnetic material 1 allows the outer peripheral surface of the first soft magnetic particle 3 to be strongly bonded to the resin 7 even under high temperature after absorption of moisture (at the time of reflow, for example), inhibiting generation of cracks or the like. In this manner, the magnetic material 1 can achieve high mechanical strength after compression molding.

The binding layer 3D is formed on at least part of the surface of the insulating film 3C of the first soft magnetic particle 3, that is, on at least part of the outer peripheral surface of the first soft magnetic particle 3 by spraying the silane coupling agent onto the first soft magnetic particle processed up to the formation of the insulating film 3C. Note that, in the following description, the first soft magnetic particle processed up to the formation of the insulating film 3C is referred to as a first soft magnetic particle 4 for the purpose of distinguishing it from the first soft magnetic particle 3 in which the binding layer 3D has been formed.

Assuming that the mass of the first soft magnetic particles 3 be 100, the mass ratio of the silane coupling agent contained in the binding layer 3D of the first soft magnetic particles 3 to the first soft magnetic particles 3 is preferably 0.02 or more and 0.06 or less (i.e., from 0.02 to 0.06). Specifically, in Examples described later, the strength of a sample formed by compression of the magnetic material 1 was maximum when the above-described mass ratio was 0.04, and the strength was relatively small when the mass ratio was in the range of 0.02 to 0.04 or 0.04 to 0.02.

### Second Soft Magnetic Particle

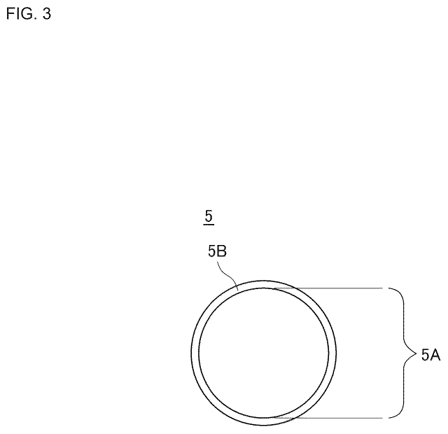

FIG. 3 is an explanatory diagram for description of a configuration example of the second soft magnetic particle 5. As illustrated in FIG. 3, the second soft magnetic particle 5 has a particle nucleus 5A composed of soft magnetic metal, and an insulating film 5B formed on the surface of the particle nucleus 5A.

The soft magnetic metal constituting the particle nucleus 5A is, for example, crystalline or non-crystalline iron (Fe). Specifically, the particle body of the second soft magnetic particle 5 includes, for example, carbonyl iron powder having an onion skin structure, which has an Fe content of 95 wt % or more and 99.8 wt % or less (i.e., from 95 wt % to 99.8 wt %), preferably 97 wt % or more and 99.8 wt % or less (i.e., from 97 wt % to 99.8 wt %). The carbonyl iron powder may contain carbon (C), oxygen (O), nitrogen (N), and/or sulfur(S) as an impurity. In addition, the carbonyl iron powder that serves as the particle nucleus 5A may have an Fe oxide film on the surface thereof.

The soft magnetic metal constituting the particle nucleus 5A of the second soft magnetic particle 5 is not limited to Fe, but may be an iron-based metal magnetic substance containing Fe and other metals, similarly to the first soft magnetic particle 3 described above.

The insulating film 5B of the second soft magnetic particle 5 may be composed of a sol-gel reaction product containing silica, for example, and may contain a hydrocarbon group having a linear moiety with 8 or more carbon atoms. Specific examples of the hydrocarbon group having a linear moiety with 8 or more carbon atoms include an alkyl group being a chain saturated hydrocarbon group. Note that the hydrocarbon group having a linear moiety with 8 or more carbon atoms may be one or more hydrocarbon groups selected from the group consisting of an octyl group, a nonyl group, a decyl group, an undecyl group, a dodecyl group, a tridecyl group, a tetradecyl group, a pentadecyl group, a hexadecyl group, a heptadecyl group, and an octadecyl group. The alkyl group may be any one of a primary alkyl group, a secondary alkyl group, or a tertiary alkyl group.

The hydrocarbon group having a long chain moiety can be formed as a product of a sol-gel reaction in which a mixture of tetraethoxysilane (TEOS) and a silane coupling agent containing the above-described hydrocarbon group is used, for example.

At this time, due to the hydrocarbon group having a linear moiety with 8 or more carbon atoms added to the insulating film 5B of the second soft magnetic particle 5, a base body formed by compression molding of the magnetic material 1 containing the first soft magnetic particles 3 and the second soft magnetic particles 5 can be improved in filling factor of the magnetic powder 2.

A mechanism of improvement in filling factor of the magnetic powder 2 is not restricted by any specific theory, but is surmised as follows. As described above, the base body is formed by compression molding of the magnetic material 1 containing the first soft magnetic particles 3, the second soft magnetic particles 5, and the resin 7. In this case, when either one of the soft magnetic particles (the second soft magnetic particle 5, for example) has a surface containing the hydrocarbon group having a linear moiety with 8 or more carbon atoms, hydrogen bonding and/or dipole-dipole interaction between the second soft magnetic particle 5 and a polar group (such as an epoxy group and/or a hydroxyl group) contained in the resin 7 can be reduced, and thereby the second soft magnetic particles 5 can exhibit improved fluidity (slidability) at the time of compression molding.

As a result, the highly slidable second soft magnetic particles 5 can enter gaps between the first soft magnetic particles 3. It is considered that the above mechanism can improve the filling factor of the soft magnetic particles in the base body in comparison to the case where the soft magnetic particles do not have the long chain hydrocarbon groups. The improvement in filling factor of the soft magnetic particles leads to an increase in density of the soft magnetic powder in the base body, resulting in an increase in relative magnetic permeability of the base body.

### Resin

The resin 7 may be any epoxy resin. The epoxy resin in the present disclosure may be any one of a variety of known epoxy resins without limitation, but preferably has a rigid structure such as a plurality of aromatic rings from the viewpoint of mechanical strength. For example, a bisphenol A novolac type epoxy resin, a bisphenol F novolac type epoxy resin, a triazine skeleton-containing epoxy resin, a fluorene skeleton-containing epoxy resin, a triphenyl methane type epoxy resin, a biphenyl type epoxy resin, a xylylene type epoxy resin, a phenol-aralkyl type epoxy resin, a biphenyl-aralkyl type epoxy resin, a naphthalene type epoxy resin, an anthracene type epoxy resin, a dicyclopentadiene type epoxy resin, or the like is preferable from the viewpoint mentioned above. These may be used alone or in combination of two or more thereof. An epoxy resin curing agent may be of any type without limitation which can cure the epoxy resin, but is preferably a solid at room temperature from the viewpoint of work efficiency. Examples thereof include phenol novolac resins, cresol novolac resins, bisphenol A type novolac resins, triazine skeleton-containing phenol resins, triphenyl methane type phenol resins, phenol-aralkyl resins, biphenyl-aralkyl resins, dicyclopentadiene type phenol novolac resins, and imidazoles. These epoxy resin curing agents may be used alone or in combination of two or more thereof.

The weight percent (wt %) of the resin 7 is preferably 2.7 wt % or more and 4.0 wt % or less (i.e., from 2.7 wt % to 4.0 wt %), with respect to the total weight of the magnetic material 1. Specifically, it was found in Examples described later that the magnetic permeability (μ) of a sample formed by compression of the magnetic material 1 was maximum when the above-described weight percent was 3.5 wt %. The sample had a relatively small magnetic permeability (μ) when the above-described weight percent was in the range of 2.7 wt % to 3.5 wt % or 3.5 wt % to 4.0 wt %. In addition, it was found that the sample was not able to be formed when the above-described weight percent was 2 wt % or 4.5 wt %.

### Method of Manufacturing Magnetic Material

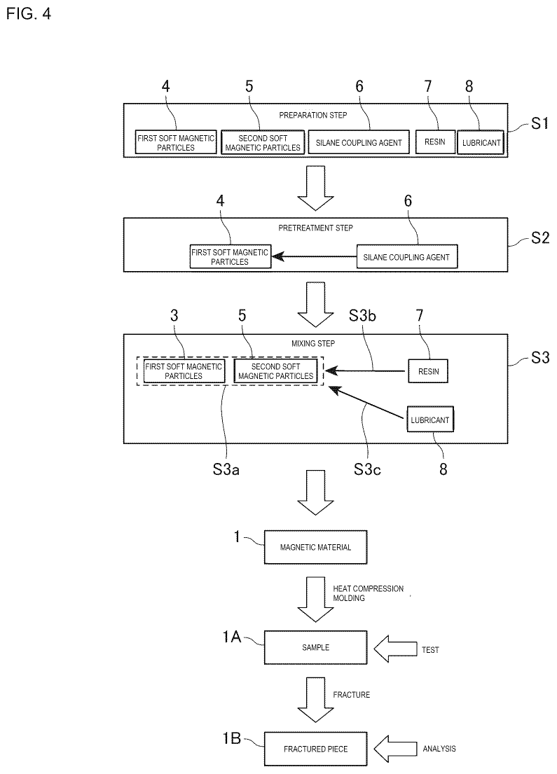

FIG. 4 is an explanatory diagram for description of an outline of a process of manufacturing the magnetic material 1 according to the embodiment. As illustrated in FIG. 4, the process of manufacturing the magnetic material 1 includes a preparation step (S1), a pretreatment step (S2), and a mixing step (S3).

First, first soft magnetic particles 4 before the binding layer 3D is formed thereon, the second soft magnetic particles 5, a silane coupling agent 6, the resin 7, and a lubricant 8 are prepared in the preparation step (S1).

The particle nuclei 3A of the first soft magnetic particles 4 are produced by gas atomization, for example. That is, each metal serving as a raw material of the particle nuclei 3A is melted by heating in an induction furnace to be turned into a molten metal, and the resulting molten metal is ejected through an ejection hole together with a jet of argon gas being an inert gas, thereby producing metal fine particles. Subsequently, the resulting particles are cooled in water and then dried, and thereby formed into the particle nuclei 3A of the first soft magnetic particles 4. The average particle diameter of the particle nuclei 3A can be adjusted by, for example, adjusting the velocity of the argon gas jet stream used for ejection of the molten metal in the gas atomization, and/or adjusting the diameter of the ejection hole.

In the case where the particle nuclei 3A are to be composed of an amorphous metal having an average particle diameter of, for example, 20 μm or more, the spinning water atomization process (SWAP) can be employed, in which metal fine particles formed from the above-described molten metal are rapidly cooled by a high-speed rotating water flow.

The particle nuclei 3A are exposed to water and/or an oxygen atmosphere in the process of cooling by water and subsequent drying, and the oxide film 3B is thus formed on the surfaces of the particle nuclei 3A. The oxide film 3B can have a desired thickness by controlling the time for exposure to water or an oxygen atmosphere, and/or controlling the oxygen concentration in the environment of manufacturing the particle nuclei 3A. In addition, the thickness of the oxide film 3B on the surfaces of the particle nuclei 3A can be increased by further exposing the particle nuclei 3A, after dried as described above, to a high-temperature oxygen atmosphere. Note that the average particle diameters of the particle nuclei 3A before and after the formation of the oxide film 3B and formation of the insulating film 3C to be described later can be regarded as substantially the same.

In the oxide film 3B formed on the surface of the particle nucleus 3A, metal oxide does not necessarily need to be uniformly distributed. For example, in the case where one or a plurality of types of metals constituting the particle nucleus 3A can form a plurality of types of oxides, the different types of oxides may be ununiformly distributed relative to each other in the oxide film 3B, and the oxide film 3B may be composed of a plurality of layers composed of different types of oxides.

Next, the insulating film 3C is formed on the oxide film 3B formed on the particle nucleus 3A. The insulating film 3C is, for example, a phosphate glass film formed by a mechanochemical method.

Metal fine particles to serve as the particle nuclei 5A of the second soft magnetic particles 5 are prepared in a manner similar to that for the first soft magnetic particles 3. The details regarding the average particle diameter of the second soft magnetic particles 5, the composition of the particle nuclei 5A, and the like are as described above. Note that the average particle diameters of the particle nuclei 5A before and after the surface treatment to be described later can be regarded as substantially the same.

Next, the insulating film 5B is formed on the surface of the particle nucleus 5A. The insulating film 5B may be formed by a sol-gel reaction in which silica is employed as a component, where a hydrocarbon group having a linear moiety with 8 or more carbon atoms may be contained, as described above. For example, the insulating film 5B can be formed through a sol-gel reaction employing a surface treatment agent containing tetraethoxysilane being an alkoxide and a silane coupling agent having the above-described hydrocarbon group. This allows the insulating film 5B, which is the sol-gel reaction product, to be formed on the particle nucleus 5A.

The alkoxide is not limited to tetraethoxysilane, and can be represented by a chemical formula M-(OR) n. In the formula, the metal species M of the metal alkoxide is preferably one or more selected from the group consisting of Li, Na, Mg, Al, Si, K, Ca, Ti, Cu, Sr, Y, Zr, Ba, Ce, Ta, and Bi. Any alkoxy group such as a methoxy group, an ethoxy group, and/or a propoxy group may be selected as the alkoxy group OR of the metal alkoxide.

The silane coupling agent 6 can be represented by a chemical formula R′-Si(OR)₃. In the formula, R′ is a hydrocarbon group having a linear moiety with 8 or more carbon atoms, and may be, for example, one or more hydrocarbon groups selected from the group consisting of an amino group, an epoxy group, an imidazole group, and a mercapto group. In the formula, OR is an alkoxy group, preferably a methoxy group or an ethoxy group.

Examples of the silane coupling agent 6 include 3-aminopropyltrimethoxysilane, 3-(2-aminoethylamino) propyltrimethoxysilane, 3-glycidoxy propyltrimethoxysilane, 3-[2-hydroxy-3-(1H-imidazol-1-yl) propoxy]propyltrimethoxysilane, and 3-mercaptopropyltrimethoxysilane.

The resin 7 may be any epoxy resin. The epoxy resin in the present disclosure may be any one of a variety of known epoxy resins without limitation, but preferably has a rigid structure such as a plurality of aromatic rings from the viewpoint of mechanical strength.

The lubricant 8 is an additive used for the purpose of reducing friction among particles of the magnetic powder 2 and facilitating release from a mold at the time of molding. Examples of the lubricant 8 include metal soaps such as barium sulfate, zinc stearate, calcium stearate, and lithium stearate, long chain hydrocarbons such as wax, and silicone oils. For example, the lubricant 8 may contain 0.2 wt % or less of nanosilica, and 0.2 wt % or less of lithium stearate, with respect to the total weight of the magnetic material 1.

Following the preparation step (S1), the pretreatment step (S2) of forming the binding layer 3D on the outer peripheral surfaces of the first soft magnetic particles 4 is performed.

In the pretreatment step (S2), the silane coupling agent is sprayed to the first soft magnetic particles 4, thereby forming the binding layer 3D on at least part of the surface of the insulating film 3C of the first soft magnetic particle 4, that is, at least part of the outer peripheral surface of the first soft magnetic particle 4. Note that the method for forming the binding layer 3D is not limited to spraying the silane coupling agent to the first soft magnetic particles 4. For example, infiltration of the silane coupling agent may be employed. However, the binding layer 3D does not necessarily need to entirely coat the outer peripheral surface of the first soft magnetic particle 3, because it is sufficient that a certain bonding strength between the particle and the resin 7 be maintained. The thickness of the binding layer 3D formed on the outer peripheral surface of the first soft magnetic particle 3 is preferably small from the viewpoint of maintaining high relative magnetic permeability of a resulting base body.

Following the pretreatment step (S2), the mixing step (S3) of mixing the first soft magnetic particles 3 and the second soft magnetic particles 5, adding the resin 7 and kneading the mixture, and further adding the lubricant 8 to produce the magnetic material 1 is performed.

Specifically, in the mixing step (S3), the first soft magnetic particles 3 and the second soft magnetic particles 5 are mixed in a powder mixer and formed into the magnetic powder 2 (S3a). In the mixing step (S3), the resin 7 is further added to the magnetic powder 2 and the mixture is kneaded (S3b). In the mixing step (S3), the lubricant is subsequently added to the kneaded material and thereby the magnetic material 1 is produced (S3c).

### EXAMPLES

The magnetic materials 1 of (Example 1) to (Example 8) were produced under different conditions of the silane coupling agent 6, and subjected to heat compression molding to be formed into samples 1A. The resulting samples 1A were stored under an environment of a predetermined temperature and a predetermined humidity for a predetermined period of time, and then determination was made through a strength test and an MSL test. Each sample 1A after the tests was fractured for observation of its fractured section, and the fractured section of a fractured piece 1B was analyzed.

Comparative Examples relative to Examples included a case where the magnetic material 1 was produced without the silane coupling agent 6 (Comparative Example 1), and a case where the magnetic material 1 was produced with the silane coupling agent 6 mixed with the resin 7 (Comparative Example 2). The sample 1A was produced also in (Comparative Example 1) and (Comparative Example 2), and the tests and analysis were performed in a manner similar to that of (Example 1) to (Example 8).

Details of (Example 1) to (Example 8), (Comparative Example 1), and (Comparative Example 2) are as shown in the table below.

TABLE 1

| | | | | | Sample | | |
|---|---|---|---|---|---|---|---|
| | | | | | Fractured by | | |
| | | | | | compression at | | |
| | | | | | 250° C. | | |
| | | | | | after 85° C. | | |
| | | | | | 85% RH 168 hr | | |
| | | | | | Si on | | |
| | | | | | surface | | |
| | | | | | of large | | |
| | Silane coupling agent | | | | particle in | | |
| | | | Amount | Powder | fractured | | |
| | Adding | | [pts · | resistance | section | Strength | MSL test |
| | method | Type | mass] | [Ω · cm] | [atom %] | [N/mm\hat{ }2] | Determination |
| Example 1 | Treat | 3-aminopropyltrimethoxysilane | 0.02 | Example 1 | 30 | 12 | G |
| | large | | | 1 × 10\hat{ }10Ω · cm | | | |
| | particles | | | | | | |
| | first | | | | | | |
| Example 2 | Treat | 3-aminopropyltrimethoxysilane | 0.04 | Example 2 | 30 | 14 | G |
| | large | | | 5 × 10\hat{ }10Ω · cm | | | |
| | particles | | | | | | |
| | first | | | | | | |
| Example 3 | Treat | 3-aminopropyltrimethoxysilane | 0.06 | Example 3 | 35 | 13 | G |
| | large | | | 6 × 10\hat{ }10Ω · cm | | | |
| | particles | | | | | | |
| | first | | | | | | |
| Example 4 | Treat | 3-aminopropyltriethoxysilane (right side) | 0.04 | Example 4 | 30 | 12 | G |
| | large | | | 5 × 10\hat{ }10Ω · cm | | | |
| | particles | | | | | | |
| | first | | | | | | |
| Example 5 | Treat | 3-(2- | 0.04 | Example 5 | 30 | 11 | G |
| | large | aminoethylamino)propyltrimethoxysilane | | 5 × 10\hat{ }10Ω · cm | | | |
| | particles | | | | | | |
| | first | | | | | | |
| Example 6 | Treat | 3-glycidoxy propyltrimethoxysilane | 0.04 | Example 6 | 30 | 9 | G |
| | large | | | 5 × 10\hat{ }10Ω · cm | | | |
| | particles | | | | | | |
| | first | | | | | | |
| Example 7 | Treat | 3-[2-hydroxy-3-(1H-imidazol-1- | 0.04 | Example 7 | 30 | 9 | G |
| | large | yl)propoxy]propyltrimethoxysilane | | 5 × 10\hat{ }10Ω · cm | | | |
| | particles | | | | | | |
| | first | | | | | | |
| Example 8 | Treat | 3-mercaptopropyltrimethoxysilane | 0.04 | Example 8 | 30 | 9 | G |
| | large | | | 5 × 10\hat{ }10Ω · cm | | | |
| | particles | | | | | | |
| | first | | | | | | |
| Comparative | None | None | 0 | Comparative | 0 | 9 | NG |
| Example 1 | | | | Example 1 | | | |
| | | | | 5 × 10\hat{ }7Ω · cm | | | |
| Comparative | Blend | 3-aminopropyltrimethoxysilane | 0.04 | Comparative | 0 | 9 | NG |
| Example 2 | with | | | Example 2 | | | |
| | resin | | | 5 × 10\hat{ }7Ω · cm | | | |

In (Example 1) to (Example 8), the silane coupling agent 6 was added in the above-described pretreatment step (S2) of the process of manufacturing the magnetic material 1. In (Comparative Example 1), the silane coupling agent 6 was not added in the production of the magnetic material 1. In (Comparative Example 2), the silane coupling agent 6 (3-aminopropyltrimethoxysilane) was added to (blended with) the resin 7 in the production of the magnetic material 1. Note that the amount of the silane coupling agent 6 added in (Comparative Example 2) was 0.04 in terms of the mass ratio (pts.mass) relative to the first soft magnetic particles 3 assuming that the mass of the first soft magnetic particles 3 was 100. In addition, the weight percent (wt %) of the resin 7 was 3.5 wt % with respect to the total weight of the magnetic material 1, in any case of (Example 1) to (Example 8), (Comparative Example 1), and (Comparative Example 2). As to the resin 7, a biphenyl-aralkyl type epoxy resin was employed as the epoxy resin, and a biphenyl-aralkyl type resin was employed as the resin curing agent.

In (Example 1) to (Example 5), an amine-based silane coupling agent having an amine group employed as the silane coupling agent 6 was added in the pretreatment step (S2). Specifically, in (Example 1) to (Example 3), 3-aminopropyltrimethoxysilane was added as the silane coupling agent 6. In (Example 4), 3-aminopropyltriethoxysilane (right side) was added as the silane coupling agent 6. In (Example 5), 3-(2-aminoethylamino) propyltrimethoxysilane was added as the silane coupling agent 6.

The amount of 3-aminopropyltrimethoxysilane added in (Example 1) was 0.02 in terms of the mass ratio (pts.mass) relative to the first soft magnetic particles 3 assuming that the mass of the first soft magnetic particles 3 was 100. The amount of 3-aminopropyltrimethoxysilane added in (Example 2) was 0.04 in terms of the above-described mass ratio (pts.mass). The amount of 3-aminopropyltrimethoxysilane added in (Example 3) was 0.06 in terms of the above-described mass ratio (pts.mass). In this manner, the same type of silane coupling agent 6 (3-aminopropyltrimethoxysilane) was added in (Example 1) to (Example 3) but the amount (pts.mass) thereof varied like 0.02, 0.04, and 0.06. The amount of the silane coupling agent 6 added in (Example 4) and (Example 5) was 0.04 in terms of the above-described mass ratio (pts.mass).

In (Example 6), an epoxy-based silane coupling agent having an epoxy group employed as the silane coupling agent 6 was added in the pretreatment step (S2). Specifically, 3-glycidoxy propyltrimethoxysilane was added as the silane coupling agent 6 in (Example 6). The amount of the silane coupling agent 6 added in (Example 6) was 0.04 in terms of the above-described mass ratio (pts.mass).

In (Example 7), an imidazole-based silane coupling agent having an imidazole group employed as the silane coupling agent 6 was added in the pretreatment step (S2). Specifically, 3-[2-hydroxy-3-(1H-imidazol-1-yl) propoxy]propyltrimethoxysilane was added as the silane coupling agent 6 in (Example 7). The amount of the silane coupling agent 6 added in (Example 7) was 0.04 in terms of the above-described mass ratio (pts.mass).

In (Example 8), a mercapto-based silane coupling agent having a mercapto group employed as the silane coupling agent 6 was added in the pretreatment step (S2). Specifically, 3-mercaptopropyltrimethoxysilane was added as the silane coupling agent 6 in (Example 8). The amount of the silane coupling agent 6 added in (Example 8) was 0.04 in terms of the above-described mass ratio (pts.mass).

### Production and Test of Sample

A toroidal ring for a radial crushing strength test was formed as the sample 1A from the magnetic material produced in each of (Example 1) to (Example 8), (Comparative Example 1), and (Comparative Example 2). The toroidal ring was formed by the following procedures.
(Procedure 1): Preliminary molding (putting granulated powder in a mold and pressing the powder)
(Procedure 2): Maturing molding (preheating the mold, putting a preliminarily-molded ring in the mold and preheating the ring, pressing the ring by heating, and taking out the ring and additionally hardening the ring in an oven)

The amount of the magnetic material loaded in the preliminary molding (Procedure 1) was 2 g. An air press was used for the formation. The mold used for the formation had an inner diameter of 8.4 mm and an outer diameter of 12.6 mm. The pressure at the time of formation was 60 Mpa, and the formation time was 5 s.

The amount of the preliminarily-molded ring loaded in (Procedure 2) was 2 g (8.4 mm in inner diameter, 12.6 mm in outer diameter). The model of equipment used for the preheating was Hot Plate ND-1A, manufactured by AS ONE Corporation. An air press was used for the formation. The model of equipment used for the additional hardening was Constant-Temperature Drying Oven OF-450V, manufactured by AS ONE Corporation. As to the conditions at the time of the formation, the formation temperature was 195° C., the formation time was 200 s, and the pressure was 20 MPa. As to the additional hardening conditions, the oven hardening temperature was 200° C., and the oven hardening time was 1 hr.

The first magnetic particles 3 after the pretreatment step (S2) were subjected to measurement of the electrical resistance in powdery form before the heat compression (hereinafter referred to as “powder resistance”). The method for measuring the powder resistance was as follows. A measurement apparatus was Hiresta-UX MCP-HT800 (manufactured by Nittoseiko Analytech Co., Ltd.). The sample (10 g) was pressed in the measurement apparatus at a pressure of 20 kN while a voltage of 10 V was applied, in which the radius of a counter electrode (probe) was 10 mm. The results of measurement of the powder resistance are as shown in Table 1 with fractions rounded up. As can be obviously seen from Table 1, the powder resistance was 10⁹ Ω·cm or more in Examples 1 to 8. In contrast, the powder resistance was about 10⁷ Ω·cm in Comparative Examples. The results showed that the withstanding voltage of the granulated powder was higher in Examples 1 to 8 than in Comparative Examples.

The sample 1A (toroidal ring) produced by the above-described procedures was subjected to a high-temperature radial crushing strength test after moisture absorption. The test was performed by the following procedures.
(Procedure 1): Moisture absorption by the sample 1A (toroidal ring)
(Procedure 2): High-temperature radial crushing strength test after moisture absorption by the sample 1A (toroidal ring)

The moisture absorption in (Procedure 1) was performed in accordance with a moisture absorption process specified in JIS regarding the MSL test, following the conditions of MSL 1 (environmental conditions, moisture absorption time). Specifically, the sample 1A (toroidal ring: 8 mm in inner diameter, 13 mm in outer diameter) was loaded in an amount of 2 g in (Procedure 1). The model of equipment was a small environmental tester SH-222, manufactured by ESPEC CORP. The moisture absorption was performed under an environment of 85° C. and 85% RH for a period of 168 hr.

In (Procedure 2), the sample 1A (toroidal ring) after moisture absorption was subjected to a test in accordance with JIS Z2507 (Sintered metal bearing-Determination of radial crushing strength). Specifically, the sample 1A (toroidal ring: 8 mm in inner diameter, 13 mm in outer diameter, 2 g) after moisture absorption was subjected to the test in (Procedure 2). The model of equipment used for the test was autograph AG-20kNXDplus, manufactured by Shimadzu Corporation. The test method was as follows. The sample 1A (toroidal ring) was placed between plates of the equipment so as to have the axis parallel to the horizontal planes of the plates. Subsequently, heat compression was performed by pressing down the plate while heating the sample 1A (toroidal ring), thereby measuring a maximum strength [N/mm\hat{ }2] at which the sample 1A (toroidal ring) was fractured. Note that the temperature at the time of the compression was set at 250° C., and the test rate was 0.1 mm/s.

The strengths measured in (Example 1) to (Example 8), (Comparative Example 1), and (Comparative Example 2) are as shown in the above table. Specifically, 14 [N/mm\hat{ }2] of (Example 2), was maximum. For example, among the cases in which the amount (pts.mass) of adding the silane coupling agent 6 of the same type (3-aminopropyltrimethoxysilane) was varied, the strength was maximum in the case of 0.04. Among the cases in which the type of the silane coupling agent 6 was varied, the strength was maximum in the case where the silane coupling agent 6 was (3-aminopropyltrimethoxysilane).

The fractured piece 1B after the fracture was subjected to determination through the MSL test, and an elemental analysis was made for the surface of the first soft magnetic particle 3 in the fractured section. The determination through the MSL test was made in accordance with JIS regarding the MSL test, in which a determination of “accepted” (G) was made when no deterioration in mechanical characteristics (no crack or the like) was recognized, whereas a determination of “rejected” (NG) was made when any deterioration was recognized, as a result of observation of the appearance of the fractured piece 1B.

The results of determination through the MSL test for (Example 1) to (Example 8), (Comparative Example 1), and (Comparative Example 2) are as shown in the above table. Specifically, a determination of “accepted” (G) was made in the cases of (Example 1) to (Example 8), in which the silane coupling agent 6 was added in the pretreatment step (S2) of the above-described process of manufacturing the magnetic material 1. A determination of “rejected” (NG) was made in the cases of (Comparative Example 1) and (Comparative Example 2). From these results, an improvement in strength of the sample 1A due to the pretreatment step (S2) was recognized.

In the elemental analysis of the surface of the first soft magnetic particle 3 in the fractured section of the fractured piece 1B, Si on the surface was detected by auger electron spectroscopy (AES). Specifically, a qualitative and semi-quantitative analysis was performed in AES with PHI 680 manufactured by ULVAC-PHI, Inc.

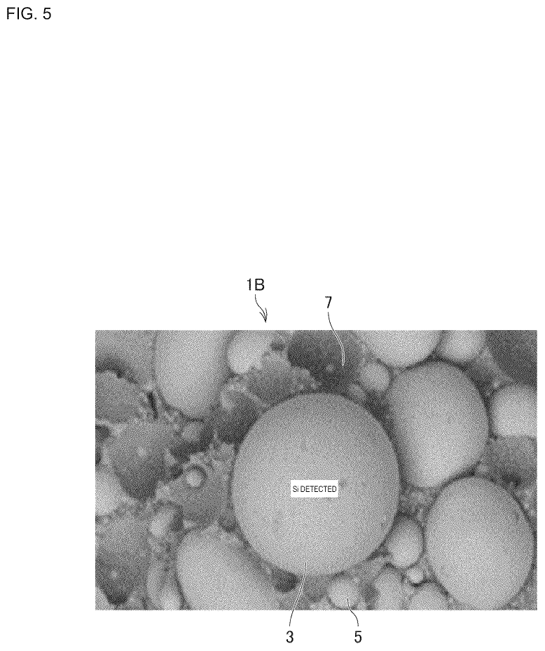

FIG. 5 is an enlarged image of part of the fractured piece 1B. As illustrated in FIG. 5, the surface of the first soft magnetic particle 3 exposed in the fractured section of the fractured piece 1B was analyzed by AES, and Si was detected.

The results of Si detection by AES for (Example 1) to (Example 8), (Comparative Example 1), and (Comparative Example 2) are as shown in the above table (atomic composition percentage: atm %). Specifically, Si was recognized on the surface of the first soft magnetic particle 3 in the cases of (Example 1) to (Example 8). The Si is considered to be derived from the silane coupling agent 6 contained in the binding layer 3D on the outer peripheral surface of the first soft magnetic particle 3. In contrast, no Si was recognized on the surface of the first soft magnetic particle 3 in the cases of (Comparative Example 1) and (Comparative Example 2). That is, it was confirmed that the addition of the silane coupling agent 6 in the pretreatment step (S2) of the process of manufacturing the magnetic material 1 led to the formation of the binding layer 3D containing the silane coupling agent 6 on the outer peripheral surface of the first soft magnetic particle 3. It is also considered that, due to the above-described binding layer 3D, the silane coupling agent 6 contained in the binding layer 3D facilitated the bonding with the resin 7 and increased the interface strength in (Example 1) to (Example 8), as compared to the cases of (Comparative Example 1) and (Comparative Example 2).

Next, (Example 2) which was the highest in strength among (Example 1) to (Example 8) was modified into (Example 2-1) to (Example 2-5) which varied in the weight percent (wt %) of the resin 7 with respect to the total weight of the magnetic material 1. Subsequently, the magnetic permeability of the magnetic materials 1 of (Example 2-1) to (Example 2-5) was measured. Details of (Example 2-1) to (Example 2-5) are as shown in the following table.

TABLE 2

| | Content of resin | |
|---|---|---|
| | [wt %] | Magnetic permeability μ |
| Example 2-1 | 3.5 | 26 |
| Example 2-2 | 2.7 | 24 |
| Example 2-3 | 4 | 15 |
| Example 2-4 | 2 | Not moldable |
| | | Failure in filling |
| Example 2-5 | 4.5 | Not moldable |
| | | Failure in granulation |

Specifically, the weight percent of the resin 7 was 3.5 wt % in (Example 2-1). The weight percent of the resin 7 was 2.7 wt % in (Example 2-2). The weight percent of the resin 7 was 4 wt % in (Example 2-3). The weight percent of the resin 7 was 2 wt % in (Example 2-4). The weight percent of the resin 7 was 4.5 wt % in (Example 2-5).

The model of equipment used for the measurement of the magnetic permeability was Impedance Analyzer E4990A, manufactured by Keysight Technologies. The measurement was performed under conditions of an environment of room temperature and a frequency of 0.1 to 100 MHz, and the analysis was performed for the real part of magnetic permeability μ′ (by units of 1 MHz).

As shown in the above table, the magnetic permeability u was the highest (26) in the case where the weight percent of the resin 7 was 3.5 wt %. The magnetic permeability u decreased when the weight percent of the resin 7 was in the range of 3.5 wt % to 2.7 wt % or in the range of 3.5 wt % to 4 wt %. The results showed that the weight percent of the resin 7 is particularly preferably 3.5 wt %.

In the case where the weight percent of the resin 7 was 2 wt % (the content of the resin 7 was small), the resin 7 was insufficient for causing heat flow and thus the filling with the magnetic powder 2 was not sufficiently achieved, and accordingly, the sample 1A was not able to be formed. In contrast, in the case where the weight percent of the resin 7 was 4.5 wt % (the content of the resin 7 was large), the resin 7 was too much and thus the magnetic powder 2 clumped, and accordingly, the sample 1A was not able to be formed. The results showed that the content of the resin 7 preferably falls within a predetermined range (2.7 wt % or more and 4.0 wt % or less (i.e., from 2.7 wt % to 4.0 wt %)) for formation of the sample 1A.

### Inductor

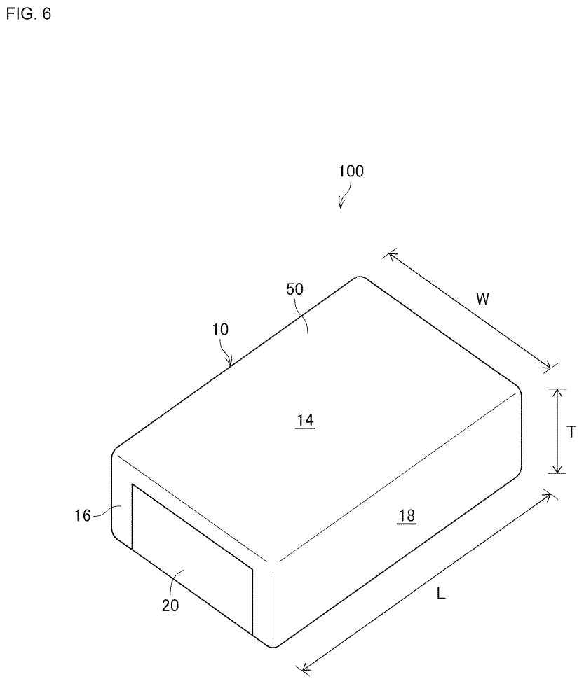

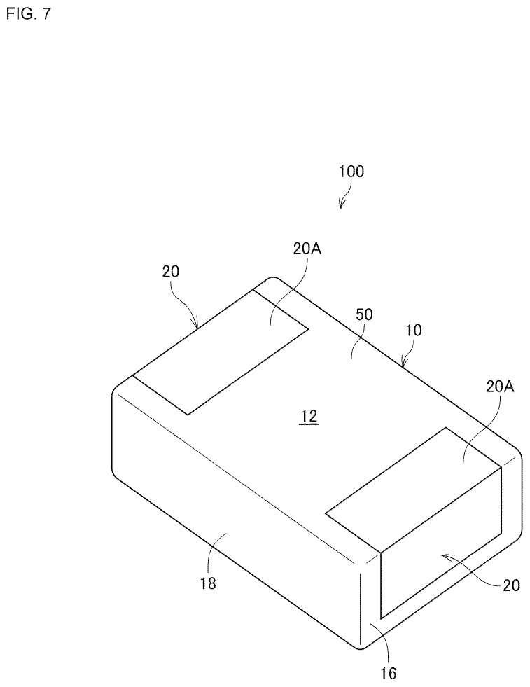

An inductor including a base body formed by compression molding of the magnetic material 1 will be described. FIGS. 6 and 7 are perspective views schematically illustrating the configuration of the inductor. Specifically, FIG. 6 is a perspective view illustrating a top surface 14 side of an inductor 100, and FIG. 7 is a perspective view illustrating a mounting surface 12 side of the inductor 100.

As illustrated in FIGS. 6 and 7, the inductor 100 is configured as a surface-mount electronic component, and includes a base body 10 having a substantially rectangular parallelepiped shape formed by compression molding of the magnetic material 1, and a pair of outer electrodes 20 provided on surfaces of the base body 10. In the inductor 100, one surface of the base body 10 serves as the mounting surface 12 to be mounted on a surface of a circuit board (not illustrated). The base body 10 is covered with a base body protection film 50 except for the outer electrodes 20.

Regarding the base body 10, a surface opposing the mounting surface 12 is hereinafter referred to as the top surface 14 and, out of the four lateral surfaces other than the mounting surface 12 and the top surface 14, a pair of surfaces in which extended portions 34 (described later) of a coil 30 are located are hereinafter referred to as first lateral surfaces 16, and the remaining pair of surfaces are hereinafter referred to as second lateral surfaces 18. The first lateral surfaces 16 and the second lateral surfaces 18 are also regarded as surfaces of the base body 10 each located in a radial direction of a wound portion 32 of the coil 30 (described later). In the following description, the mounting surface 12 and the top surface 14 opposing each other are also referred to as a pair of principal surfaces.

The length from the mounting surface 12 to the top surface 14 is defined as a thickness T of the base body 10. The length of a short side of the top surface 14 is defined as a width W of the base body 10. The length of a long side of the top surface 14 is defined as a length L of the base body 10.

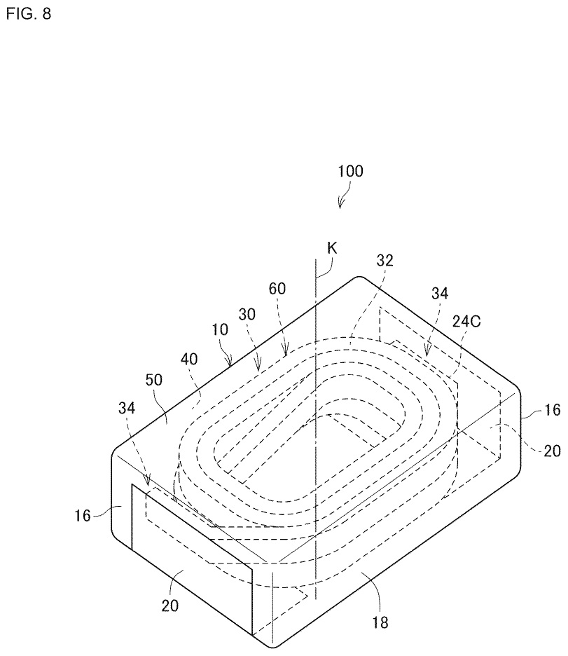

FIG. 8 is a transparent perspective view transparently illustrating an internal configuration of the inductor 100. As illustrated in FIG. 8, the base body 10 includes the coil 30 and a core 40 in which the coil 30 embedded, and is configured as a coil-encapsulated magnetic component in which the coil 30 is encapsulated within the core 40. The coil 30 is an air core coil component formed by winding a conductive wire 31. The core 40 is a molded body formed into a substantially rectangular parallelepiped shape by compression molding by compacting mixed powder, which includes a mixture of soft magnetic powder and a resin, with the coil 30 enclosed in the mixed powder.

The coil 30 includes the wound portion 32 formed by winding the conductive wire 31, and the pair of extended portions 34 extended from the wound portion 32. The wound portion 32 is formed by spirally winding the conductive wire 31 such that the conductive wire 31 has both ends located on the outer periphery but is continuous in the inner periphery. In the inside of the base body 10, the coil 30 is embedded in the core 40 in an orientation in which a central axis K of the wound portion 32 is along the direction of the thickness T of the base body 10. Each of the extended portions 34 is extended from the wound portion 32 to a corresponding one of the pair of first lateral surfaces 16.

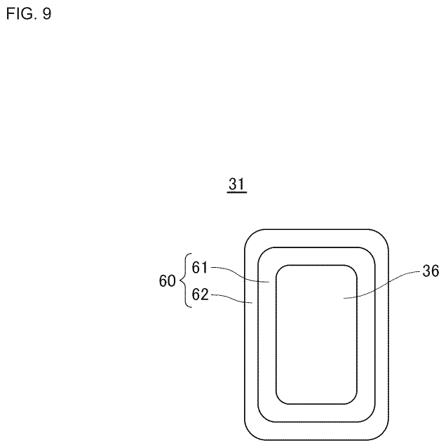

FIG. 9 is a cross-sectional view illustrating a cross-section orthogonal to a length direction of the conductive wire 31 forming the coil 30. The conductive wire 31 forming the coil 30 is composed of a copper wire 36 and an insulating coating member 60 coating the copper wire 36. The insulating coating member 60 includes an insulating coating layer 61 having electrical insulation properties and a fused layer 62 formed on the insulating coating layer 61. In the coil forming step, the conductive wire 31 is wound while being heated and therefore the fused layer 62 melts to cause neighboring portions of the conductive wire 31 of the wound portion 32 to be fixed to each other, and accordingly, the wound portion 32 does not readily lose its shape after the coil is formed. In addition, the insulating coating layer 61 reliably insulates the coil 30 from the core 40.

The pair of outer electrodes 20 are each an L-shaped member extending from a corresponding one of the first lateral surfaces 16 to the mounting surface 12 of the base body 10. Each of the outer electrodes 20 is connected to a corresponding one of the extended portions 34 of the coil 30 in the first lateral surface 16. A portion 20A extended to the mounting surface 12 is electrically connected to wiring lines of the circuit board by an appropriate mounting method such as soldering.

The inductor 100 having the above-described configuration is, for example, a power inductor and is used as a choke coil for a DC-DC converter circuit, a power supply circuit, or the like though which a large current flows, in electronic equipment, such as personal computers, DVD players, digital cameras, television sets, cellular phones, smartphones, car electronics, and medical or industrial machinery. However, the usage of the inductor 100 is not limited thereto, and the inductor 100 can be used for a filter circuit, a rectifying and smoothing circuit, or the like.

### Outline of Inductor Manufacturing Process

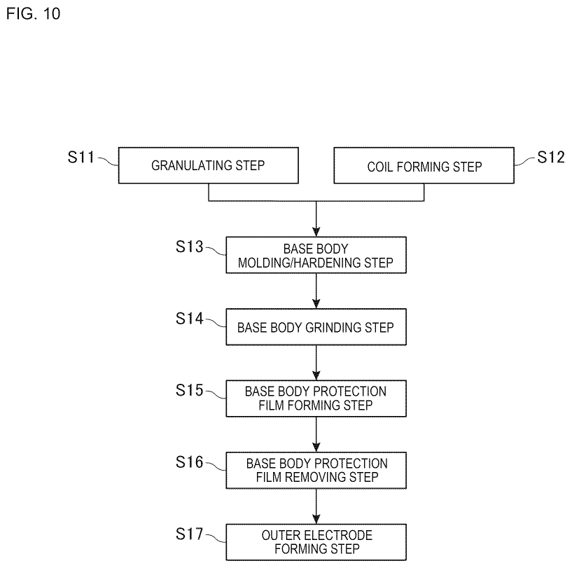

FIG. 10 is an explanatory diagram for description of an outline of a process of manufacturing the inductor 100. As illustrated in FIG. 10, the process of manufacturing the inductor 100 includes a granulating step (S11), a coil forming step (S12), a base body molding/hardening step (S13), a base body grinding step (S14), a base body protection film forming step (S15), a base body protection film removing step (S16), and an outer electrode forming step (S17).

The granulating step (S11) is a step of granulating the magnetic material 1 to be contained in the core 40. Specifically, the granulating step (S11) corresponds to the process of manufacturing the magnetic material 1 described above.

The coil forming step (S12) is a step of forming the coil 30 from the conductive wire 31 coated with the insulating coating member 60. In this step, the coil 30 is shaped by winding the conductive wire 31 by a method called “alpha winding” to have the wound portion 32 and the pair of extended portions 34 described above. The alpha winding refers to spirally winding the conductive wire 31, which functions as a conductor, in two stages such that the extended portions 34 including the winding-start portion and the winding-end portion are located on the outer periphery. The number of turns in the coil 30 is not limited, but may be 6.5, for example.

The base body molding/hardening step (S13) is a step of molding the molded body from which the base body 10 is to be formed. The magnetic material 1 obtained through the granulating step is used as a molding material for the molded body.

In the base body molding/hardening step (S13), the magnetic material 1 is subjected to premolding to be formed into tablets (solid objects of predetermined shapes), and the tablets and the coil 30 are disposed in a cavity of a mold. Pressure is then applied with a punch while the cavity is heated, thereby performing compression molding of the molded body with the coil 30 enclosed therein. In the subsequent base body molding/hardening step (S13), the hardened molded body is taken out from the cavity, and the molded body is polished. The polishing is performed by barrel polishing so that the corners of the molded body can be rounded.

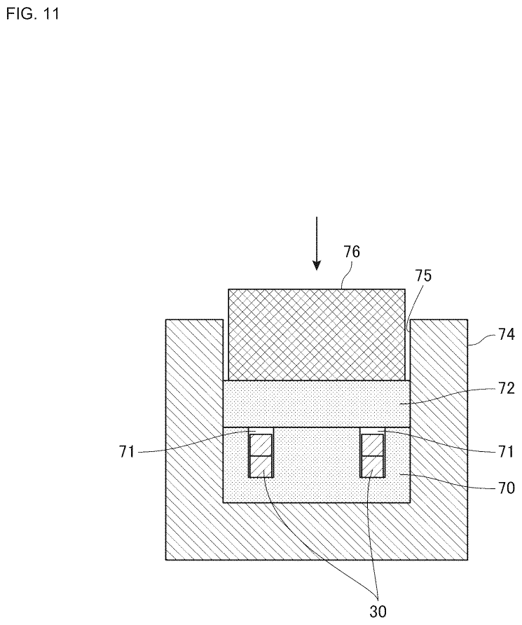

FIG. 11 is an explanatory diagram for description of one aspect of formation of the base body. As illustrated in FIG. 11, the premolded tablets include two kinds of tablets, that is, a first tablet 70 of an appropriate shape (E-shape in cross section, for example) having a groove 71 to accommodate the coil 30 and a second tablet 72 of an appropriate shape (I-shape in cross section, or plate shape for example) to cover the groove 71 of the first tablet 70.

At the time of compression molding, the first tablet 70 with the coil 30 fitted in the groove 71 and the second tablet 72 are disposed in a cavity 75 of a mold 74 in a layered manner. Pressure is then applied with a punch 76 in the layered direction from the first tablet 70 side or/and the second tablet 72 side (the second tablet 72 side in the example of FIG. 11) while heat is applied to the first tablet 70 and the second tablet 72, thereby unifying the first tablet 70, the coil 30, and the second tablet 72. Note that not the premolded tablets but the magnetic material 1 obtained in the granulating step may be put in the cavity as it is and subjected to compression molding.

The pressure applied at the time of compression molding is preferably such a pressure that allows the first soft magnetic particles 3 and the second soft magnetic particles 5, which compose the magnetic powder 2, to maintain their shapes before molding of the base body 10 without being crushed even after the molding. With such a pressure, damage to the insulating films 3C and 5B on the surfaces of the first soft magnetic particles 3 and the first soft magnetic particles 4 is reduced, which can reduce a decrease in insulation performance (that is, a decrease in withstanding voltage).

The base body grinding step (S14) is a step of scraping (that is, grinding) the second lateral surfaces 18 of the molded body obtained in the base body molding/hardening step (S13) until the width W is reduced to a predetermined width, by causing abrasive grains to act on the second lateral surfaces 18. Through this step, the base body 10 having a predetermined width, which is downsized from the width W of the molded body, is obtained. Since the downsizing process reduces the distance between the coil 30 within the base body 10 and each second lateral surface 18 (also referred to as a side gap), the proportion of the portion occupied by the coil 30 in the radial direction of the wound portion 32 of the coil 30 is increased. In addition, since the molded body obtained by compression molding is formed into the base body 10 of a predetermined size through the grinding process, variations in dimension of the base body 10 can be reduced as compared to the case where the base body 10 is controlled to have a predetermined size only by compression molding. Note that polishing (barrel polishing, for example) may be performed for chamfering corners generated by the grinding of the second lateral surfaces 18 in the base body grinding step (S14). In the case where the downsizing or the like of the base body 10 is not needed, the base body grinding step (S14) may be omitted and the process may proceed to the base body protection film forming step (S15).

The base body protection film forming step (S15) is a step of forming the base body protection film 50 on the entire surface of the base body 10 grinded to have a predetermined size in the base body grinding step (S14).

Examples of a material for the base body protection film 50 include thermosetting resins such as epoxy resins, polyimide resins, and phenol resins, and thermoplastic resins such as polyethylene resins and polyamide resins. Note that such a resin may further contain a filler containing a silicon oxide, a titanium oxide, or the like.

In the base body protection film forming step (S15), the material for the base body protection film 50 is applied to the entire surface of the base body 10 appropriately by, for example, coating or dipping and cured, thereby forming the base body protection film 50.

The base body protection film removing step (S16) is a step of removing the base body protection film 50 on electrode formation portions where the outer electrodes 20 are to be formed (predetermined portions on the first lateral surfaces 16, for example), and removing the insulating coating member 60 of the extended portions 34 of the coil 30 exposed at the electrode formation portions, by irradiating the base body 10 the entire surface of which is coated with the base body protection film 50 with a laser beam. Note that an etching process may be performed for cleaning the surfaces of the electrode formation portions after the removal of the insulating coating member 60 with the laser beam, in the base body protection film removing step (S16).

The outer electrode forming step (S17) is a step of forming the outer electrodes 20 by plating on the electrode formation portions from which the base body protection film 50 has been removed in the base body protection film removing step (S16). Note that the outer electrode forming step (S17) may be performed before the base body protection film forming step (S16).

In the outer electrode forming step (S17), the outer electrodes 20 are formed by subjecting the magnetic material 1 and the extended portions 34 of the coil 30 which are exposed on the surface of the base body 10 to a plating treatment. In the plating treatment, the outer electrodes 20 are formed by growing a copper (Cu) layer by plating. Note that a nickel (Ni) layer and a tin (Sn) layer may be formed in this order to be layered on the copper (Cu) layer by plating. Alternatively, an aluminum (Al), silver (Ag), gold (Au), or palladium (Pd) layer may be employed in place of the copper (Cu) layer.

The outer electrodes 20 may be formed by sputtering, or composed of a conductive resin, copper plates, or the like. The outer electrode 20 does not necessarily have the L-shape as illustrated in the figures, but may have a so-called five-sided electrode structure, or be a bottom electrode.

According to the inductor 100 manufactured by using the magnetic material 1 as described above, the mechanical strength of the core 40 can be maintained. Specifically, the inductor 100 can maintain a sufficient mechanical strength to resist even a high pressure inside the base body 10 generated due to, for example, sudden evaporation of absorbed moisture at the time of reflow. For this reason, a decrease in inductance resulting from a crack inside the base body 10 can be inhibited in the inductor 100.

All the embodiments and modifications described above are merely examples of one aspect of the present disclosure, and can be appropriately modified or applied without departing from the spirit of the present disclosure. In addition, any elements of the above-described embodiments may be combined to create another embodiment.

Directions such as horizontal, orthogonal, and vertical directions and various numerical values, shapes, and materials in the above-described embodiments encompass ranges in which the same functions and effects as those of the directions, numerical values, shapes, and materials are achieved (so-called equivalents), unless otherwise specified.

### Configurations Supported by the Above-Described Embodiments

The above-described embodiments support the following configurations.

### Configuration 1

A magnetic material including magnetic powder containing a first magnetic particle and a second magnetic particle smaller in particle diameter than the first magnetic particle; and a resin, wherein at least part of an outer peripheral surface of the first magnetic particle has a binding layer that contains a silane coupling agent. According to the magnetic material of Configuration 1, high mechanical strength can be exhibited after compression molding.

### Configuration 2

The magnetic material according to Configuration 1, wherein 10 atm % or more of Si is detected in an elemental analysis of a surface of the first magnetic particle in which the binding layer is formed. According to the magnetic material of Configuration 2, Si derived from the silane coupling agent contained in the binding layer formed on at least part of the outer peripheral surface of the first magnetic particle can be detected. Therefore, it can be confirmed that the outer peripheral surface (interface) of the first magnetic particle exhibits high mechanical strength due to the silane coupling agent.

### Configuration 3

The magnetic material according to Configuration 2, wherein the elemental analysis is performed on a fractured section after the magnetic material is subjected to formation by compression and is stored under an environment of a predetermined temperature and a predetermined humidity for a predetermined period of time. According to the magnetic material of Configuration 3, Si derived from the silane coupling agent contained in the binding layer formed on at least part of the outer peripheral surface of the first magnetic particle can be detected in the case where the magnetic material formed by compression is stored under an environment of a predetermined temperature and a predetermined humidity for a predetermined period of time.

### Configuration 4

The magnetic material according to any one of Configurations 1 to 3, wherein a surface of a particle nucleus of the first magnetic particle has an insulating film that contains low-melting glass. According to the magnetic material of Configuration 4, the melting point at the time of formation of the insulating film on the surface of the particle nucleus of the first magnetic particle can be lowered, and therefore the insulating film can be easily formed.

### Configuration 5

The magnetic material according to any one of Configurations 1 to 4, wherein the particle nucleus of the first magnetic particle is an Fe—Si alloy or an Fe—Si-Cr amorphous alloy. According to the magnetic material of Configuration 5, the particle nucleus of the first magnetic particle is composed of an Fe—Si alloy or an Fe—Si-Cr amorphous alloy, and therefore high magnetic permeability can be achieved.

### Configuration 6

The magnetic material according to Configuration 4, wherein the low-melting glass is zinc phosphate. According to the magnetic material of Configuration 6, zinc phosphate can be employed as the low-melting glass.

### Configuration 7

The magnetic material according to any one of Configurations 1 to 6, wherein a surface of a particle nucleus of the second magnetic particle has an insulating film that contains silica. According to the magnetic material of Configuration 7, the insulating film can be easily formed on the surface of the particle nucleus of the second magnetic particle.

### Configuration 8

The magnetic material according to any one of Configurations 1 to 7, wherein the particle nucleus of the second magnetic particle is an Fe-based crystalline alloy. According to the magnetic material of Configuration 8, the particle nucleus of the second magnetic particle is composed of an Fe-based crystalline alloy, and therefore high magnetic permeability can be achieved.

### Configuration 9

The magnetic material according to any one of Configurations 1 to 8, wherein the silane coupling agent contains an amino group, an epoxy group, an imidazole group, or a mercapto group. According to the magnetic material of Configuration 9, the chemical bond between the outer peripheral surface (interface) of the first magnetic particle and the resin results in high mechanical strength at the interface of the first magnetic particle.

### Configuration 10

The magnetic material according to any one of Configurations 1 to 9, wherein a mass ratio of the silane coupling agent relative to the first magnetic particle is 0.02 or more and 0.06 or less (i.e., from 0.02 to 0.06), when a mass of the first magnetic particle is taken as 100. According to the magnetic material of Configuration 10, the mechanical strength at the interface of the first magnetic particle imparted by the silane coupling agent can be further increased.

### Configuration 11

The magnetic material according to any one of Configurations 1 to 10, wherein the resin is an epoxy resin. According to the magnetic material of Configuration 11, the thermohardening properties of the magnetic material can be improved. In addition, the fluidity (slidability) at the time of formation by compression can be improved.

### Configuration 12

The magnetic material according to any one of Configurations 1 to 11, wherein a weight percent of the resin is 2.7 or more and 4.0 or less (i.e., from 2.7 to 4.0) with respect to a total weight of the magnetic material. According to the magnetic material of Configuration 12, formation of the base body for the inductor by compression, for example, can be appropriately performed.

### Configuration 13

The magnetic material according to any one of Configurations 1 to 12, wherein an insulation resistance of the first magnetic particle is 10⁹ Ω·cm or more. According to the magnetic material of Configuration 13, the base body or the like formed by compression molding has a high withstanding voltage.

### Configuration 14

A method for manufacturing a magnetic material, the method including forming a binding layer containing a silane coupling agent on at least part of an outer peripheral surface of a first magnetic particle; and mixing the first magnetic particle on which the binding layer is formed, a second magnetic particle smaller in particle diameter than the first magnetic particle, and a resin. According to the method for manufacturing a magnetic material of Configuration 14, the magnetic material exhibiting high mechanical strength after compression molding can be provided.

### Configuration 15

An inductor including a metal magnetic body containing the magnetic material according to any one of Configurations 1 to 13; and a coil embedded in the metal magnetic body. According to the inductor of Configuration 15, the metal magnetic body has high mechanical strength. For example, generation of cracks in the metal magnetic body at the time of reflow can be inhibited, and therefore a decrease in inductance can be inhibited.

What is claimed is:

1. A magnetic material comprising:
magnetic powder including a first magnetic particle and a second magnetic particle smaller in particle diameter than the first magnetic particle; and
a resin, wherein
at least part of an outer peripheral surface of the first magnetic particle has a binding layer that includes a silane coupling agent.

2. The magnetic material according to claim 1, wherein
10 atm % or more of Si is detected in an elemental analysis of a surface of the first magnetic particle in which the binding layer is configured.

3. The magnetic material according to claim 2, wherein
the elemental analysis is performed on a fractured section after the magnetic material is subjected to formation by compression and is stored under an environment of a predetermined temperature and a predetermined humidity for a predetermined period of time.

4. The magnetic material according to claim 1, wherein
a surface of a particle nucleus of the first magnetic particle has an insulating film that includes low-melting glass.

5. The magnetic material according to claim 4, wherein
the particle nucleus of the first magnetic particle is an Fe—Si alloy or an Fe—Si-Cr amorphous alloy.

6. The magnetic material according to claim 4, wherein
the low-melting glass is zinc phosphate.

7. The magnetic material according to claim 1, wherein
a surface of a particle nucleus of the second magnetic particle has an insulating film that includes silica.

8. The magnetic material according to claim 7, wherein
the particle nucleus of the second magnetic particle is an Fe-based crystalline alloy.

9. The magnetic material according to claim 1, wherein
the silane coupling agent includes an amino group, an epoxy group, an imidazole group, or a mercapto group.

10. The magnetic material according to claim 1, wherein
a mass ratio of the silane coupling agent relative to the first magnetic particle is from 0.02 to 0.06, when a mass of the first magnetic particle is taken as 100.

11. The magnetic material according to claim 1, wherein
the resin is an epoxy resin.

12. The magnetic material according to claim 1, wherein
a weight percent of the resin is from 2.7 to 4.0 with respect to a total weight of the magnetic material.

13. The magnetic material according to claim 1, wherein
an insulation resistance of the first magnetic particle is 10⁹ Ω·cm or more.

14. A method for manufacturing a magnetic material, the method comprising:
forming a binding layer including a silane coupling agent on at least part of an outer peripheral surface of a first magnetic particle; and
mixing the first magnetic particle on which the binding layer is formed, a second magnetic particle smaller in particle diameter than the first magnetic particle, and a resin.

15. An inductor comprising:
a metal magnetic body including the magnetic material according to claim 1; and
a coil embedded in the metal magnetic body.

16. An inductor comprising:
a metal magnetic body including the magnetic material according to claim 2; and
a coil embedded in the metal magnetic body.

17. An inductor comprising:
a metal magnetic body including the magnetic material according to claim 3; and
a coil embedded in the metal magnetic body.

18. An inductor comprising:
a metal magnetic body including the magnetic material according to claim 4; and
a coil embedded in the metal magnetic body.

19. An inductor comprising:
a metal magnetic body including the magnetic material according to claim 5; and
a coil embedded in the metal magnetic body.

20. An inductor comprising:
a metal magnetic body including the magnetic material according to claim 6; and
a coil embedded in the metal magnetic body.
